(19) United States
(12) Patent Application Publication
(10) Pub. No.: US 2024/0003485 A1
(43) Pub. Date: Jan. 4, 2024

(54) LAPTOP COMPUTER STAND

(71) Applicant: Guangzhou Haichuan Technology Development Co., Ltd., Guangzhou (CN)

(72) Inventor: Jinhua Cheng, Guangzhou (CN)

(21) Appl. No.: 18/468,828

(22) Filed: Sep. 18, 2023

(30) Foreign Application Priority Data
Sep. 8, 2023 (CN) 202322462225.6

(51) Int. Cl. F16M 13/00

(52) U.S. Cl. CPC F16M 13/005

(57) ABSTRACT

The present disclosure discloses a laptop computer stand. The stand includes a placement board, a background plate rotatably connected to a top of the placement board, and a support plate rotatably connected to a bottom of the placement board; a fixed connection member is arranged on the bottom of the placement board; one side of the support plate is hinged to the fixed connection member through a rotating shaft; when the support plate rotates a certain angle around the rotating shaft, the support plate and the placement board form a triangular support state; the background plate is then rotated outwards. Therefore, the laptop computer stand provided by the present disclosure can show various usage states, so as to be applied to different types of laptop computers with different sizes, thereby achieving multiple purposes.

### TECHNICAL FIELD

The present disclosure relates to the technical field of stands, and specifically, to a laptop computer stand.

### BACKGROUND

With the development of electronics technologies and computer technologies, laptop computers have become an important component of people's work and life. People usually need to face a display screen for a long time, but different people and different usage scenarios have different requirements for a height of a display screen of a laptop computer. If the height of the display screen of the laptop computer is not suitable, the user experience is poor, and an incorrect usage posture is easily caused, resulting in tension and strain in the muscles around the shoulders, cervical vertebra, and lumbar vertebra, which can lead to diseases such as cervical spondylosis and lumbar spondylosis and affect the human health.

Based on the above problems, various types of laptop computer stands have emerged. However, due to a great variety of laptop computers having significant differences in size, different types of laptop computers correspond to different support frames, and different types of laptop computer support frames are usually not interchangeable. When it is necessary to support different types of laptop computers with different sizes, various support frames need to be provided at the same time, which will reduce the use efficiency of a certain support frame and cause unnecessary idleness.

### SUMMARY

The present disclosure aims to provide a laptop computer stand to solve the above problem, so as to be applied to different types of laptop computers with different sizes. This is described in detail below.

In order to achieve the above objective, the present disclosure provides the following technical solution:

A laptop computer stand provided according to the present disclosure includes a placement board, a background plate rotatably connected to a top of the placement board, and a support plate rotatably connected to a bottom of the placement board; a fixed connection member is arranged on the bottom of the placement board; one end of the support plate is hinged to the fixed connection member through a rotating shaft;

when the support plate rotates a certain angle around the rotating shaft, the support plate and the placement board form a triangular support state, so as to support a laptop computer placed at the top of the placement board; and when the placement board and the background plate abut against and are horizontally arranged on a desktop, the support plate is configured to support a laptop computer placed at the bottom of the placement board.

By the adoption of the above laptop computer stand. The laptop computer stand includes a placement board, a background plate rotatably connected to a top of the placement board, and a support plate rotatably connected to a bottom of the placement board; a fixed connection member is arranged on the bottom of the placement board; one side of the support plate is hinged to the fixed connection member through a rotating shaft; when the support plate rotates a certain angle around the rotating shaft, the support plate and the placement board form a triangular support state; the background plate is then rotated outwards, so that a bottom of the computer can be placed at the top of the placement board, and the computer is backed up against the background plate; when the placement board and the background plate abut against and are horizontally arranged on a desktop, the support plate can be used as the background plate; and at the same time, a portable laptop computer can be placed at the bottom of the placement board, and the portable laptop computer is backed up against the support plate. Therefore, the laptop computer stand provided by the present disclosure can show various usage states, so as to be applied to different types of laptop computers with different sizes, thereby achieving multiple purposes.

As a preference, a first groove is arranged at the bottom of the placement board, and a shape of an outer contour of the first groove adapts to a shape of the support plate; and the support plate can be stored in the first groove through a storage assembly and is covered at the placement board.

As a preference, the storage assembly includes a first fixed connection rod arranged on a back surface of the support plate, a second fixed connection rod arranged on the first groove, a first sliding sheet connected to the first fixed connection rod, and a second sliding sheet connected to the second fixed connection rod; and the first sliding sheet and the second sliding sheet are slidably connected through a buckle.

As a preference, the first sliding sheet is provided with a sliding chute, and the second sliding sheet is embedded in the sliding chute; and when the support plate rotates around the rotating shaft, the second sliding sheet is driven to slide in the sliding chute.

As a preference, a second groove is further arranged at a bottom of the first groove; a shape of an outer contour of the second groove adapts to a shape of the first sliding sheet; and when the support plate is covered at the bottom of the placement board, the first sliding sheet is embedded in the second groove.

As a preference, several antiskid members are arranged at the bottom of the placement board.

As a preference, both the bottom of the placement board and a surface of the background plate are engraved with honeycomb-shaped patterns.

### BRIEF DESCRIPTION OF THE DRAWINGS

In order to describe the embodiments of the present disclosure or the technical solutions in the prior art more clearly, drawings required to be used in the embodiments or the illustration of the existing art will be briefly introduced below. Obviously, the drawings in the illustration below are merely some embodiments of the present disclosure. Those ordinarily skilled in the art also can acquire other drawings according to the provided drawings without doing creative work.

FIG. 1 is a front view of a laptop computer stand in the present disclosure;

FIG. 2 is a side view of a laptop computer stand in the present disclosure;

FIG. 3 is a schematic diagram of a usage state of a laptop computer stand in the present disclosure; and

FIG. 4 is a schematic diagram of another usage state of a laptop computer stand in the present disclosure.

Reference signs are described below:

placement board (1), background plate (2), support plate (3), first groove (11), storage assembly (12), first fixed connection rod (121), second fixed connection rod (122), first sliding sheet (123), second sliding sheet (124), buckle (125), second groove (13), and stand (100).

### DETAILED DESCRIPTION OF THE EMBODIMENTS

In order to make the purposes, technical solutions and advantages of the present disclosure clearer, the technical solutions of the present disclosure will be described in detail below. Obviously, the described embodiments are a part of the embodiments of the present disclosure only, not all the embodiments. Based on the embodiments in the present disclosure, all other embodiments obtained by a person of ordinary skill in the art without creative work shall fall within the protection scope of the present disclosure.

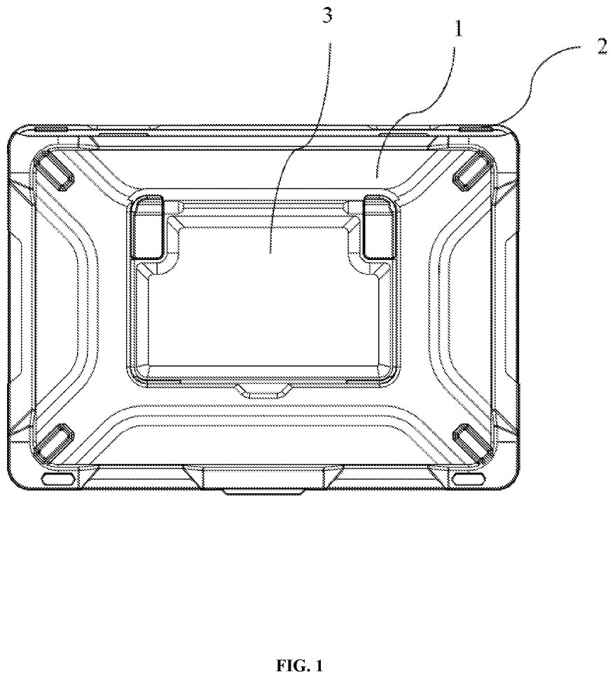

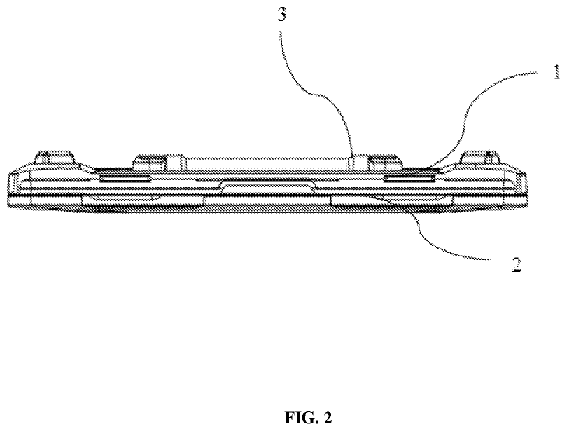

As shown in FIG. 1 to FIG. 4, the present disclosure provides a laptop computer stand (100), including: a placement board (1), a background plate (2), and a support plate (3). A size and shape of the placement board (1) are consistent with a size and shape of the background plate (2), and the background plate (2) is hinged to a top of the placement board (1) through a rotating shaft. A bottom of the placement board (1) is provided with a fixed connection member. A length and width of the support plate (3) are both less than a length and width of the placement board (1), and one side of the support plate (3) is hinged to the fixed connection member through a rotating shaft. The entire laptop computer stand can be transformed to different usage states by adjusting the angles between the placement board (1), the background plate (2), and the support plate (3).

One of the usage states is that when the support plate (3) rotates at a certain angle around the rotating shaft, the support plate (3) and the placement board (1) form a triangular support state, so as to support a laptop computer placed at the top of the placement board (1), and the laptop computer is backed up against the background plate (2). Another usage state is that when the placement board (1) and the background plate (2) abut against and are horizontally placed on a desktop, a laptop computer is backed up against the support plate (3).

When the support plate (1) is configured to support a laptop computer placed at the bottom of the placement board (1), as the length and width of the support plate (3) are less than the length and width of the placement board (1), the support plate can only support a portable or small-sized laptop computer at this time. When the support plate (3) and the placement board (1) form the triangular support state to support the laptop computer placed at the top of the placement board (1), due to a large size of the background plate (2), a large-sized laptop computer can be carried. Therefore, the laptop computer stand provided in this scheme can show various usage states, so as to be applied to different types of laptop computers with different sizes, thereby achieving multiple purposes.

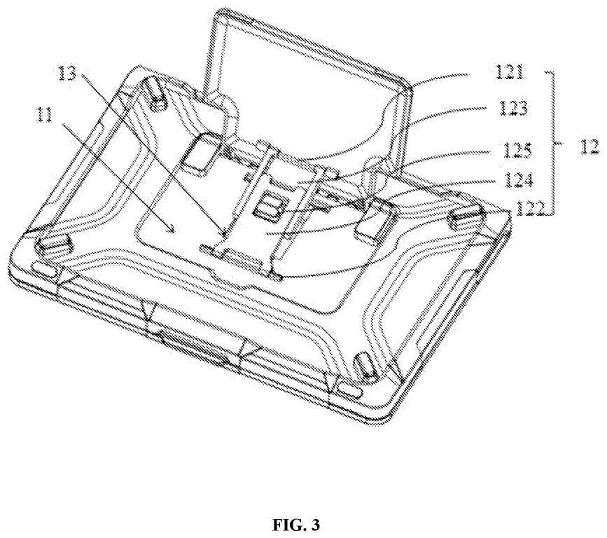

As one of the usage states of the laptop computer stand (100), as shown in FIG. 3, a first groove (11) is arranged at the bottom of the placement board (1), and a shape of an outer contour of the first groove (11) adapts to a shape of the support plate (3). The support plate (3) can be stored in the first groove (11) through a storage assembly (12) and is covered at the placement board (1). The storage assembly (12) includes a first fixed connection rod (121), a second fixed connection rod (122), a first sliding sheet (123), a second sliding sheet (124), and a buckle (125). The first fixed connection rod (121) is fixedly arranged on a back surface of the support plate (1). The second fixed connection rod is fixedly arranged on the first groove (11), and the first groove (11) is further provided with a second groove (13). One end of the first sliding sheet is connected to the first fixed connection rod (121), and the other end is connected to the second sliding sheet (124) through the buckle (125). The other end of the second sliding sheet (124) is connected to the second fixed connection rod (122). When the support plate (3) is stored in the first groove (11), the first sliding sheet (123) is embedded in the second groove (13) as a shape of an outer contour of the second groove (13) adapts to a shape of the first sliding sheet (123).

When a user opens the support plate (3) stored in the first groove (11) and sets a rotation angle between the background plate (2) and the placement board (1) to be 0, a sliding chute is arranged on the first sliding sheet (123), and the second sliding sheet (124) is embedded in the sliding chute. When the support plate (1) rotates around the rotating shaft, the second sliding sheet (124) is driven to slide in the sliding chute. When the second sliding sheet (124) slides to the position of the buckle (125) of the first sliding sheet (123), a relative position between the first sliding sheet (123) and the second sliding sheet (124) is fixed through the buckle (125).

In this setting, A portable or small-sized laptop computer can be placed in the first groove (11), and a back portion of the laptop computer closely leans against the support plate (3) to achieve supporting for the portable or small-sized laptop computer. At the same time, a tilt angle of the support plate (3) can also be adjusted by manually adjusting the relative position of the buckle (125) on the first sliding sheet (123), which provides supports at different tilt angles for a computer, so as to adapt to placement habits of different users.

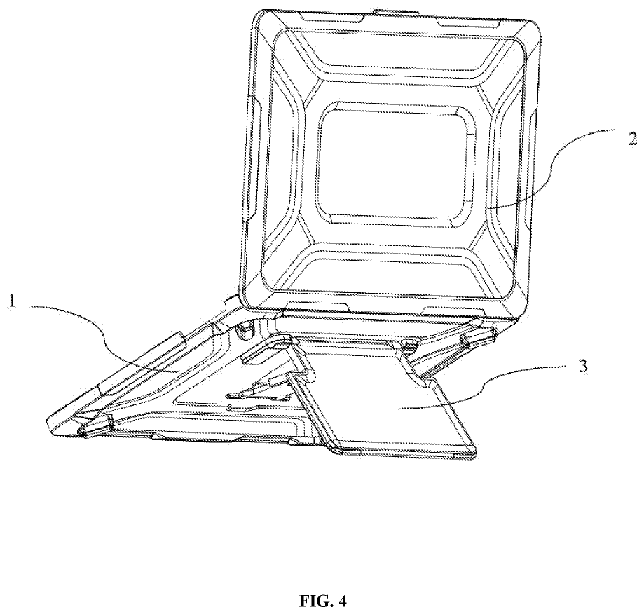

As another usage state of the laptop computer stand (100), as shown in FIG. 4, when the background plate (2) and the placement board (1) rotate to any angle, and the support plate (3) rotates at a certain angle around the rotating shaft, the support plate (3) and the placement board (1) form a triangular support state.

In this setting, a large-sized laptop computer such as a computer can be placed on the placement board (1) and backed up against the background plate (1). As the length and width of the background plate (1) are greater than the length and width of the support plate (3), this usage state of the laptop computer stand (100) is applicable to large-sized laptop computers.

As an optional implementation, several antiskid members are arranged at the bottom of the placement board (1). When the placement board (1) is placed on a desktop, a friction force between the placement board and the desktop can be increased to prevent the placement board from sliding.

As an optional implementation, both the bottom of the placement board (1) and a surface of the background plate (2) are engraved with honeycomb-shaped patterns. When a user holds the laptop computer stand, the laptop computer stand can be prevented from sliding off.

The above descriptions are only the specific implementation modes of the present disclosure, but the scope of protection of the present disclosure is not limited thereto. Any person skilled in the art can easily think of changes or replacements within the technical scope disclosed by the present disclosure, which shall be covered by the scope of protection of the present disclosure. Therefore, the scope of protection of the present disclosure shall be subject to the scope of protection of the claims.

What is claimed is:

1. A laptop computer stand, comprising a placement board, a background plate rotatably connected to a top of the placement board, and a support plate rotatably connected to a bottom of the placement board, wherein a fixed connection member is arranged on the bottom of the placement board; one side of the support plate is hinged to the fixed connection member through a rotating shaft;
when the support plate rotates a certain angle around the rotating shaft, the support plate and the placement board form a triangular support state, so as to support a laptop computer placed at the top of the placement board; and when the placement board and the background plate abut against and are horizontally arranged on a desktop, the support plate is configured to support a laptop computer placed at the bottom of the placement board.

2. The laptop computer stand according to claim 1, wherein a first groove is arranged at the bottom of the placement board, and a shape of an outer contour of the first groove adapts to a shape of the support plate; and the support plate is stored in the first groove through a storage assembly and is covered at the placement board.

3. The laptop computer stand according to claim 2, wherein the storage assembly comprises a first fixed connection rod arranged on a back surface of the support plate, a second fixed connection rod arranged on the first groove, a first sliding sheet connected to the first fixed connection rod, and a second sliding sheet connected to the second fixed connection rod; and the first sliding sheet and the second sliding sheet are slidably connected through a buckle.

4. The laptop computer stand according to claim 3, wherein the first sliding sheet is provided with a sliding chute, and the second sliding sheet is embedded in the sliding chute; and when the support plate rotates around the rotating shaft, the second sliding sheet is driven to slide in the sliding chute.

5. The laptop computer stand according to claim 4, wherein a second groove is further arranged at a bottom of the first groove; a shape of an outer contour of the second groove adapts to a shape of the first sliding sheet; and when the support plate is covered at the bottom of the placement board, the first sliding sheet is embedded in the second groove.

6. The laptop computer stand according to claim 1, wherein several antiskid members are arranged at the bottom of the placement board.

7. The laptop computer stand according to claim 1, wherein both the bottom of the placement board and a surface of the background plate are engraved with honeycomb-shaped patterns.
